(19) United States
(12) Patent Application Publication
(10) Pub. No.: US 2017/0116558 A1
(43) Pub. Date: Apr. 27, 2017

(54) Unmanned Aircraft System Deployment and Analytics Using the Same

(71) Applicant: Caterpillar Inc., Peoria, IL (US)

(72) Inventors: Stephen Pierz, Peoria, IL (US); Leslie Paulson, Peoria, IL (US); Todd D. Crawford, Hanna City, IL (US)

(73) Assignee: Caterpillar Inc., Peoria, IL (US)

(21) Appl. No.: 14/923,968

(22) Filed: Oct. 27, 2015

(51) Int. Cl. G06Q 10/06; B64C 39/02

(52) U.S. Cl. CPC G06Q 10/063112; B64C 39/024; B64C 2201/126

(57) ABSTRACT

Systems and method for managing deployment of UAS and analytics using the same, are disclosed. One method includes receiving first data comprising a criteria associated with a UAS operation, wherein the criteria comprises an analytics component, receiving second data comprising data associated with a plurality of available UAS operators, causing display of a UAS operator listing comprising identifications of one or more UAS operators of the plurality of available UAS operators, the displayed UAS operator listing determined based, at least, on the first data and the second data, receiving an indication of a selected UAS operator from the one or more UAS operators of the UAS operator listing, receiving aerial data collected via a UAS associated with the selected UAS operator, wherein the aerial data comprises analytics data based at least on the analytics criteria.

### TECHNICAL FIELD

This disclosure relates generally to unmanned systems and more particularly to a systems and method for managing deployment of unmanned systems and analytics using the same.

### BACKGROUND

An entity such as an individual or business may be involved with data analysis, construction, marine activities, utilities, pipelines, mining, agriculture, logging, or the like, and may have an interest in a particular site, such as a worksite. Such worksites may include various environmental characteristics, structures, machines, equipment, personnel, and the like. Accordingly, having up-to-date information relating to the worksite is important to the management of the worksite and work being implemented at the worksite. However, gathering information relating to the worksite may be difficult due to location, size and scope of the worksite, and/or the dynamic nature of the worksite, for example. Accordingly, improvements in gathering information at a site are needed.

As an example, unmanned aircraft systems (UAS) may be used to provide aerial information relating to a particular site. However, current UAS technology cannot be efficiently scaled without adding significant assets (e.g., UAS) and personnel (e.g., UAS operators). Moreover, regulations (e.g., Federal Aviation Agency (FAA) regulations), the cost of the UAS technology, and the ability to analyze all the collected data complicate the addition of UAS assets and operators.

Certain services, such as those provided at http://fly4.me allow a user to request a UAS flight for aerial photography. In response to the request, UAS operators may bid on the job request for UAS flight services. However, improvements are needed in on-board analytics and data gathering, as well as, providing user access to operators having specific analytic capabilities. These and other shortcomings are addressed in the present disclosure.

### SUMMARY

This disclosure relates to systems and method for managing deployment of UAS and analytics using the same. In an aspect, a method for obtaining, by a user, aerial data collected by an unmanned aircraft system (UAS), the method comprising: receiving, by one or more processors, first data comprising a criteria associated with a UAS operation, wherein the criteria comprises an analytics component; receiving, by the one or more processors, second data comprising data associated with a plurality of available UAS operators; causing, by the one or more processors, display of a UAS operator listing comprising identifications of one or more UAS operators of the plurality of available UAS operators, the displayed UAS operator listing determined based, at least, on the first data and the second data; receiving, by the one or more processors, an indication of a selected UAS operator from the one or more UAS operators of the UAS operator listing; and receiving aerial data collected via a UAS associated with the selected UAS operator, wherein the aerial data comprises analytics data based at least on the analytics criteria.

In an aspect, a method comprises: receiving, via a user interface, a criteria associated with an unmanned system operation wherein the criteria comprises an analytics component; receiving, via the user interface, a selection of an operator from an operator listing displayed via the user interface, the operator listing comprising identifications of one or more available operators based at least on the received criteria; and receiving data collected via an unmanned system associated with the selected operator, wherein the collected data comprises analytics data based at least on the analytics component.

In an aspect, a method of providing, by an unmanned aircraft system (UAS) operator and to a user, aerial data collected by the UAS, the method comprising: receiving, via a user interface, first data comprising an indication that the UAS operator is available to collect aerial data and one or more service characteristics of the UAS operator; receiving a request for the UAS operator to collect the aerial data using a UAS, the request being transmitted to the UAS operator responsive to a selection from a UAS operator listing comprising identifications of one or more available UAS operators and determined based at least on the first data; and causing transmission of aerial data collected via the UAS associated with the UAS operator, wherein the aerial data comprises analytics data.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a block diagram of an example environment in which a platform may operate in accordance with aspects of the disclosure.

FIG. 2 illustrates a block diagram of a platform in accordance with aspects of the disclosure.

FIG. 3 illustrates a block diagram of an example method in accordance with aspects of the disclosure.

FIG. 4 illustrates a block diagram of an example method in accordance with aspects of the disclosure.

FIG. 5 illustrates a block diagram of an example method in accordance with aspects of the disclosure.

FIG. 6 illustrates a block diagram of a computer system configured to implement the methods of FIGS. 3-5.

FIG. 7 illustrates a representation of an example worksite in accordance with aspects of the disclosure.

FIG. 8 illustrates a representation an example machine in accordance with aspects of the disclosure.

### DETAILED DESCRIPTION

The systems and methods disclosed herein may provide a platform through which various users may interact to manage deployment of an unmanned system (US) such as a UAS and to preform data capture and/or analytics using the UAS. As an example, a system (e.g., platform), which may include software and/or hardware components, such as a web-based application, mobile application, and/or enterprise software, for example, may be provided to facilitate the communication between one or more UAS operators and a user (e.g., customer who needs a UAS). As a further example, the system allows a user with a particular need for a UAS operation (e.g., farm analysis, quarry analysis, building inspection, etc.) to request UAS services relating to the UAS operation. The system allows a UAS operator to accept the job request and to schedule the service. The system may be configured to verify requirements such as a section 333 (FAA) or insurance coverage, for example. The system may be configured to process user payments. Such payments may be based upon predetermined service rates, project-based rates, or other rate schedules and may be based upon a shared portion with the operator. As an example, certain UAS operation may include additional criteria such as a an analytics component. As such, various analytics components may be included in the base rate or may be additive the base rate or may be embodied as consulting fees and the like.

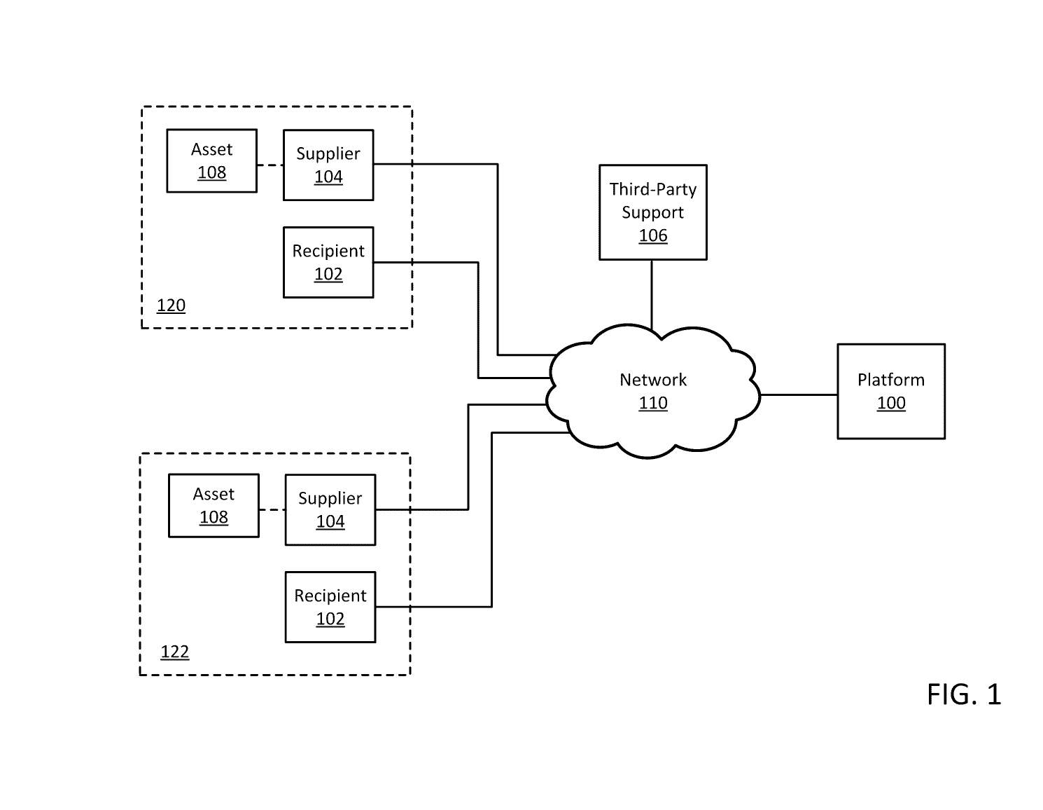

FIG. 1 depicts a block diagram of an example environment in which a platform 100 for connecting UAS operators (e.g., pilots) with users needing UAS services. The environment may include one or more recipients 102, one or more suppliers 104, and third-party support 106 which each may be connected to the platform 100 via a network 110. One or more of the suppliers 104 may each be associated with one or more assets 108 such as unmanned systems (e.g., UAS, unmanned underwater/underground systems, ground engaging unmanned systems, and the like). The recipients 102, suppliers 104, and third-party support 106 may include various users having various relationships to each other and to the platform 100. As an example, the recipients 102 may include users in need of UAS services or UAS equipment, users desiring to become a UAS operator, users desiring analytics of UAS gathered data, and the like. As another example, the suppliers 104 may include UAS operators, users providing UAS services or equipment, users providing services for becoming a UAS operator, and the like. As a further example, the third-party support 106 may include users providing data analytics, UAS technology support, payment support, and other supplemental services. The third-party support 106 may be the same entity that hosts or supports the platform 100 or may be an unrelated party.

The network 110 may include a wide area network (WAN), a local area network (LAN), the Internet, an intranet, a cellular network, a satellite network, or any other suitable network for transmitting data. The network 110 may be implemented as a wired network, a wireless network, or a combination thereof.

The platform 100, which will be discussed in further detail herein, may operate on a computing device, such as a server computer, or a series of connected computing devices. The platform 100 may be described as the software running on said computing device(s). The platform 100 may be embodied, in part, as a web interface, such as one or more web pages, accessible to the recipients 102, suppliers 104, third-party support 106, or other users over the network 110. The platform 100 may be embodied in a server-client configuration in which the recipients 102, suppliers 104, third-party support 106, or other users may utilize a local software client (e.g., a smartphone application) portion of the platform 100 to connect, via the network 110, to a remote server portion of the platform 100.

One or more suppliers 104 may connect to the platform 100 and each list one or more assets 108 associated with the supplier 104 as available for use. As used herein, the supplier 104 may refer to any type of entity, such as an individual person or a company, firm, or other organization. It is contemplated that the supplier 104 may include an individual or organization involved in an industry using heavy machinery, equipment, and tools. As an example, the supplier 104 may be an unmanned system operator such as a UAS operator and may own, lease, operate a variety of assets 108, such as one or more UASs. As such, the supplier 104 may make an idle UAS available, via the platform 100, for use by one of the recipients 102. As a further example, the UAS operator may be associated with a service characteristic such as a type of experience of the UAS operator, length of experience of the UAS operators, equipment available to the UAS operator, location of the UAS operator, availability schedule of the UAS operator, or analytics experience of the UAS operator, or a combination thereof. As such, the UAS operator may provide such information to the platform 100, which may then be used to match the UAS operator with particular requests for UAS operations.

One or more recipients 102 may connect to the platform 100 and make an arrangement, such as an agreement with the supplier 104, to use one or more of the assets 108 made available via the platform 100 by the suppliers 104. The recipient 102 may refer to any type entity, including an individual person or an organization, such as a company or firm. The recipient 102 may include an individual or organization involved in construction, marine activities, utilities, pipelines, underground/underwater activities, mining, agriculture, logging, and/or activities relating to beyond line of sight (BLOS). As an example, the recipient 102 may include a farmer needing to evaluate moisture content of particular fields. As such, the famer may utilize the platform 100 to post a request for a UAS operation requiring the analytics component of moisture detection. In this way, UAS operators having this experience and capability may be connected to the recipient 102 for engagement.

The third-party support 106 may include an entity (e.g., an individual or organization) that may provide a good or service to complement the asset 108 or use of the asset 108 and/to data gathered via the asset 108. As an example, the third-party support 106 may provide insurance for the asset 108, including insurance of a physical asset (e.g., casualty insurance on a UAS) or insurance relating to the service or personnel providing a service asset (e.g., liability insurance). The third-party support 106 may provide transportation of the asset 108 acquired via the platform 100. For instance, the third-party support 106 may be engaged to pick up a UAS at the supplier's 104 site and transport the UAS to the recipient's 102 site. As another example, the third-party support 106 may be engaged to service the asset 108 or provide supplemental data analytics relating to data captured via the asset 108. The supplemental data, for example, may be or include an algorithm provided by any developer such as a university, data farm, and/or individual, and may be made available via a platform such as an online application resource (e.g., an app store).

One or more of each of the recipients 102, the suppliers 104, and the assets 108 may be associated with (e.g., located in) a first region 120. Similarly, one or more of each of the recipients 102, the suppliers 104, and the assets 108 may be associated with (e.g., located in) a second region 122. A region may refer to a location, such as an address, or a geographical area, such as a city, county, or zip code. A region associated with one of the recipients 102 and/or suppliers 104 may be used, for example, to determine a recommended asset or third-party support 106 service for the recipient. As such, UAS resources may be available on-demand in a particular region 120, 122. In this way, users may make requests of local, on-demand UAS operators for certain operations in or near the region 120, 122.

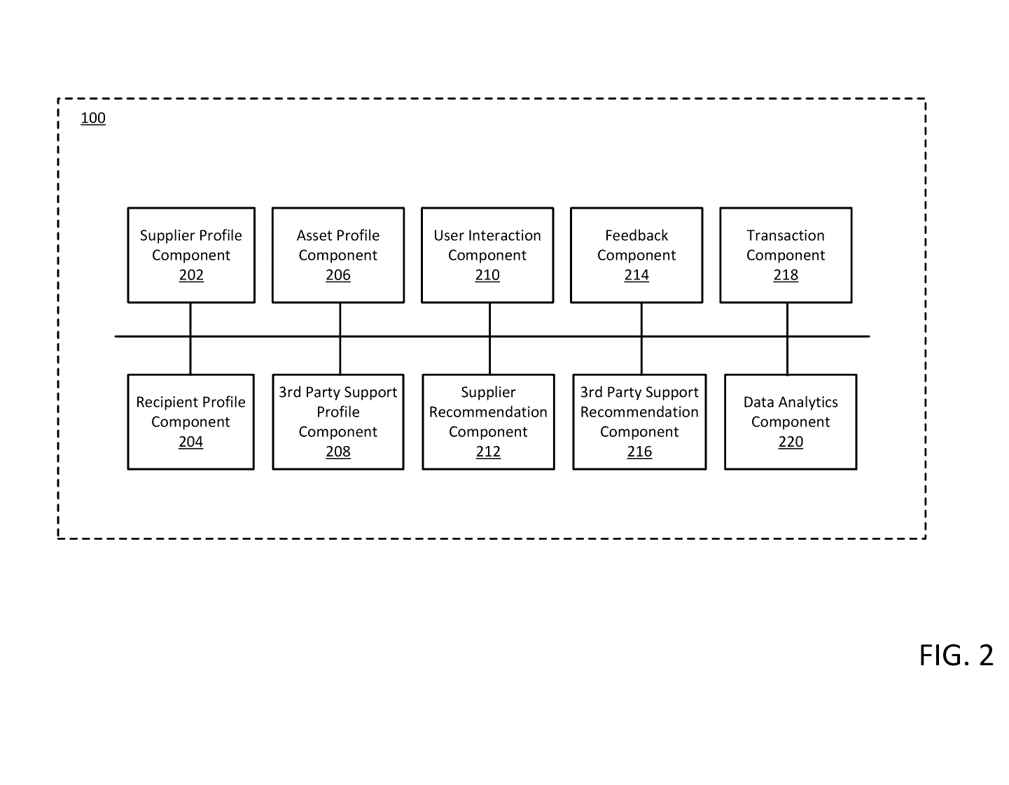

Referring to FIG. 2, the platform 100 may include a supplier profile component 202, a recipient profile component 204, an asset profile component 206, a third-party support profile component 208, a user interaction component 210, an supplier recommendation component 212, a feedback component 214, a third-party support recommendation component 216, a transaction component 218, and/or a data analytics component 220. The aforementioned components may be implemented as separate or combined software components of the platform 100. Each of the components of the platform 100 may be connected to and interact with each other component of the platform 100.

The supplier profile component 202 may create one or more profiles corresponding to the respective supplier 104, such as a UAS operator. The supplier profile component 202 may store, such as in local or remote storage, one or more profiles corresponding to the respective supplier. The supplier profile component 202 may further provide, such as to another component of the platform 100 or to a user interface of the platform 100, one or more profiles corresponding to the respective supplier. A supplier profile may include any information about the supplier 104 such as service characteristics. Examples of information in the supplier profile may include a name, a picture, an organization or company name, an industry, a number of years in operation, staff information, a link to a website associated with the supplier 104, a certification, such as by an equipment manufacturer or dealer network, a type of experience of the UAS operator, length of experience of the UAS operator, equipment available to the UAS operator, location of the UAS operator, availability schedule of the UAS operator, or analytics experience of the UAS operator, or a combination thereof, and/or a link to a webpage on a peer review website. The supplier profile may further include a location or region, such as via a region identifier, in which the supplier 104 is located or otherwise associated.

The supplier profile component 202 may interact with the asset profile component 206 and receive a listing of the assets 108 that the supplier 104 has available in the platform 100 for use or with which the supplier 104 is otherwise associated. The listing of the assets 108 associated with the supplier 104 may, accordingly, be included in the supplier profile.

The supplier profile may include feedback associated with the supplier 104. As an example, the feedback may include a rating (e.g., a number of stars or a score) or comments, such as comments left by recipients 102 or other suppliers 104 that have transacted with the supplier 104 on the platform 100. The feedback may relate to the supplier 104 in general or may be specific to a particular transaction involving the supplier 104. The feedback in the supplier profile may be generated and received via the feedback component 214.

The supplier profile may further include a listing of past transactions in which the supplier 104 has participated. Each transaction in the listing of past transactions may include identifications of the asset 108 involved in the transaction as well as other participants in the transaction (e.g., the recipient 102, other suppliers 104, and/or third-party support 106). A link or other reference may be included in each listed transaction that points to the relevant asset profile, supplier profile, recipient profile, and/or third-party support profile.

The recipient profile component 204 may create a recipient profile for each of one or more recipients 102. The recipient profile component 204 may store, such as in local or remote storage, the recipient profiles. The recipient profile component 204 may further provide, such as to other components of the platform 100 or to a user interface of the platform 100, the recipient profiles. The recipient profile may include any information pertaining to the associated recipient 102. The recipient profile may include a name, a picture, the name of an organization, an industry, a number of years in operation, staff information, a link to a website associated with the recipient 102, and/or a link to a webpage on a peer review website. The recipient profile may additionally include an indication of a region, such as the region in which the recipient 102 or a site of the recipient 102 is located.

The recipient profile may further include feedback associated with the recipient 102. The feedback may include a rating (e.g., a number of stars or a score) or comments. The feedback may be with respect to the recipient 102 in general or may be with respect to a certain transaction in which the recipient 102 has participated. The feedback may be included in the recipient profile via the feedback component 214.

The recipient profile may include a transaction history including a listing of past transactions in which the recipient 102 has participated. Each transaction in the listing of past transactions may include identifications of the asset 108 involved in the transaction as well as other participants in the transaction (e.g., the supplier 104, and/or the third-party support 106). One or more links or other references may be included in each listed transaction that points to the relevant asset profile, supplier profile, recipient profile, or third-party support profile within the platform 100.

The asset profile component 206 may create profiles of the assets 108, such as the assets 108 made available for use by the suppliers 104 via the platform 100. The asset profile component 206 may store, such as in local or remote storage, the asset profiles. Further, the asset profile component 206 may provide, such as to another component of the platform 100 or a user interface of the platform 100, the asset profiles. The asset profiles of the asset profile component 206 may not be strictly limited to reference to the assets 108 that are available for use, but may also include those assets 108 of the suppliers 104 which are not at a given time available, but may be at a later time and/or assets 108 of the recipients 102 included in the capacity information of the recipient 102 profile, for example. As examples, the asset profile may include an identifier of the asset 108, a picture and/or video of the asset 108, a price or price rate at which the asset 108 may be used, and/or a type identifier of the asset 108 (e.g., UAS type, UAS capabilities, data analytics capabilities, etc.).

The asset profile may include an indication of a region or location, such as the region or location at which the asset 108 is located or location in which the asset 108 is capable of performing particular operations. For example, the asset profile for a UAS may indicate that the UAS is at a particular address. As another example, the asset profile for a UAS may indicate that the UAS is able to travel within a 500 mile radius from a particular address or is able to travel to anywhere within one or more regions. Further, the asset profile may include information concerning delivery or transportation requirements of the asset 108. This may include whether transportation for the asset 108 must be provided by or otherwise arranged for by the recipient 102 or whether the supplier 104 will transport the asset 108 to a location requested by the recipient 102. The asset profile may further indicate the availability of the asset 108, such as how many hours the asset 108 will be available in an upcoming time period and/or a date range during which the asset 108 is or will be available.

The asset profile may include a history of the asset 108. The history of the asset 108 may include a listing of transactions, such as via the transaction component 218, in which the asset 108 was the subject. Each transaction in the listing of transactions may contain a link or other reference to the profile of the parties to the transaction (e.g., the supplier 104, the recipient 102, and/or the third-party support 106) as well as other information, such as indications of the particular service rendered, the length of time or other quantification that the asset 108, such as a service, was rendered, and/or the length of time or other quantification (e.g., number of miles, number of loads, amount of material processed) that the asset 108, such as a physical asset, was used. The history of the asset 108 may further indicate aspects of the history of the asset 108 that are without respect to a transaction in the platform 100. For example, the history of a hauling machine asset may include the total number of miles on the hauling machine.

In an aspect, the asset 108, such as a UAS, may include a telematics device that monitors, records, and transmits various operational metrics of the asset 108. In such a case, the telematics device and/or the asset 108 upon which the telematics device is located or otherwise associated may be in communication with the platform 100, such as via the network 110, and may provide usage data which may be incorporated into the history of the asset 108 in the asset's 108 asset profile. The history of the asset 108 may additionally include service (e.g., maintenance) history, particularly with respect to equipment assets.

In an aspect, the asset 108, such as an unmanned system (e.g., UAS), may include instruments and sensors such as LIDAR, RADAR, ground penetrating RADAR, thermal cameras, SLAM technology simultaneous localization and mapping. On board devices may also include CPU, WIFI and Bluetooth, magnetometer, RF polarization, water sampling, Hyperspec and Interpretation, wherein data captured via the instruments and sensors of the asset 108 may be processed via other on-board components before being transmitted external to the asset 108.

In an aspect, the platform 100 may be in communication, such as via the network 110, with a service organization, such as a dealer network. The service organization may track and store service information of the asset 108. Accordingly, the platform 100 may receive service information concerning the asset 108 from the service organization, which may be incorporated into the history of the asset 108 in the asset's 108 asset profile.

The asset profile may include feedback relating to the asset 108. The feedback may include a rating, such as a star rating or a score, for the asset 108 or comments on the asset 108. The feedback may be left by one of the recipients 102 that had previously used the asset 108. As the asset 108 may be associated with one of the suppliers 104, the feedback included in the asset profile may further incorporate feedback relating to the supplier 104 associated with the asset 108. The feedback may be entered, stored, and/or provided by the feedback component 214 of the platform 100.

The asset profile may include additional technical information describing the asset 108. For example, an asset profile may include indications of the year, make, and/or model of the asset 108. The asset profile may contain technical specifications about the asset 108. For example, the asset profile for a UAS may include flight range, aerial imaging capability, resolution of data capture, on-board data analytics, and the like.

The third-party support profile component 208 may create a profile for each of one or more of the third-party support 106. The third-party support profile component 208 may store, such as in local or remote storage, the third-party support profiles. The third-party support profile component 208 may further provide, such as to another component of the platform 100 or a user interface of the platform 100, the third-party support profiles. The third-party support profile may include the name of the third-party support 106, the name of an organization which the third-party support 106 is affiliated, an identification of a service (e.g., data analytics, insurance, transportation service, repair or maintenance service, etc.) offered by the third-party support 106, the number of years that the third-party support 106 has been in operation and/or provided a service, a link to the third-party support's 106 website, and/or a link to a webpage associated with the third-party support 106 on a peer review website. The third-party support may include an indication of a region, such as a region in which the third-party support 106 may offer its service.

The third-party support profile component 208 may create a profile for users desiring to become UAS operators. For example, a third-party, which may include the host of the platform 100, may provide information and/or training to certify a user for UAS operations, for example meeting requirements (e.g., FAA section 333). Training programs, financing, and services may be provided via the platform 100 or may be managed via the platform and performed outside the context of the platform 100.

In some aspects of the platform 100, a user of the platform 100 may embody at least two of the recipient 102, the supplier 104, and the third-party support 106. Accordingly, the supplier profile component 202, the recipient profile component 204, and/or the third-party support profile component 208 may be combined as a single component and the supplier profile, the recipient profile, and/or the third-party support profile may be embodied by a generic user profile. In such an instance, the user profile may include some or all of the aspects described herein with respect to the supplier profile, the recipient profile, and/or the third-party support profile but may have additional fields to indicate that the user may be considered one of the suppliers 104, the recipients 102, the third-party support 106, or a combination thereof.

The user interaction component 210 may facilitate interaction between users of the platform 100, such as the suppliers 104, the recipients 102, and/or the third-party support 106. As one example, the user interaction component 210 may include a forum for users to post, read, and reply to messages. The forum may be used by users, such as the recipient 102, to discuss, for example, the merits of using a particular one of the assets 108 for a particular job or operation. The recipient 102 may be directed to the forum as part of the process of selecting and requesting one of the assets 108 on the platform 100. For example, such as upon being presented with a listing of suppliers 102 and/or assets 108, the platform 100 may prompt the recipient 102 as to whether the recipient 102 wishes to create a post in a the forum regarding an appropriate asset selection. The platform 100 may create a template of a forum post including indications of aspects of the recipient's 102 planned job and the listed assets 108. The recipient 102 may supplement the forum post template with his or her own comments before posting to the forum.

The user interaction component 210 may further include facilities for users of the platform 100 to provide feedback with respect to the suitability of one or more assets 108 for a particular job. For example, the recipient 102 may propose one or more assets 108, and other users may provide feedback on the proposed one or more assets 108, such as providing a vote or a star or score rating for each of the proposed one or more assets 108. The feedback may be used in determining a listing of recommended assets via the supplier recommendation component 212, such as the assets 108 receiving the highest rating or the most votes being included in the recommended UAS operator listing.

As another example, the user interaction component 210 may provide messaging facilities for users, such as the suppliers 104, the recipients 102, and/or the third-party support 106, to send and receive messages to one another. For instance, the supplier 104 profile may contain a link or button via which the recipient 102, or other user, may message the supplier 104, such as to ask a question regarding one of the assets 108 that the supplier 104 has made available on the platform 100. Similarly, an asset profile may include a link or action element via which the recipient 102, or other user, may message the supplier 104 associated with the asset 108.

The supplier recommendation component 212 may assist the recipient 102 in selecting one of the suppliers 104, for example, based upon specified criteria associated with a UAS operation. As one example, an UAS operator listing may be determined according to an algorithm in which one or more criteria (e.g., operation criteria) supplied by the recipient 102 and/or attributes of the recipient 102 are compared or cross-referenced with one or more attributes of the suppliers 104, the assets 108, and/or the third-party support 106. In addition to the specific examples discussed below, the factors by which the determination of the UAS operator listing may be based may generally include any aspect discussed herein in relation to the supplier profile, the recipient profile, the asset profile, and/or the third-party support profile.

The UAS operator listing may be determined based, at least, on a criteria associated with a UAS operation, for example provided by the recipient 102. The criteria may include indications of the type of the asset 108 believed to be required (e.g., the type of UAS, experience of the UAS operator, type of data analytics capability, etc.) and additional details relevant to that particular type of asset 108. The criteria may include a description, attributes, and/or parameters of the planned usage of the asset 108, such as if the recipient 102 does not know the specific type of asset 108 required or which asset 108 or type of asset 108 would be most appropriate. Various planned usages may include road analysis, moisture analysis, timber analysis, quarry analysis, and other environmental and site analytics. The attributes of the planned usage may include data pertaining to the site of the planned usage, such as the size (e.g., dimensions) of the site, the type(s) of ground covering (e.g., mud, dirt, paved, or a combination thereof), whether the usage is expected to be during the day or night, or whether there are noise restrictions at the site. The attributes of the planned usage may include data pertaining to a material analysis such as a type of material (e.g. water, plants, timber, coal, ore, dirt, gravel, concrete, etc.), an amount of material, a density of material, and/or a position of the material. The attributes of the planned usage may further include data relating to other machines, tools, equipment, personnel, etc. that may be at the designated site.

The criteria may further include an indication of desired availability, such as a date range or number of hours, a price or price range, a minimum rating of the asset 108 or supplier 104, a method or schedule of payment (e.g., full payment upfront, partial payments throughout the term of usage, etc.), and/or one or more preferred suppliers 104. The criteria may additionally include an indication of region or location, such as the region or location corresponding to a site at which the asset 108 is planned to be used. The indication of region or location may not necessarily be limited to the region or location in which the site is located but may also include regions or locations for which the recipient 102 is able to arrange transportation, for example. The criteria may include an indication of delivery or transportation requirements. For instance, the criteria may indicate that the supplier 104 must provide delivery of the asset 108 to the recipient's 102 site or that the personnel providing the service asset 108 must provide their own transportation to the recipient's 102 site.

The UAS operator listing may be determined based, at least, on information in the recipient's 102 recipient profile. For example, the UAS operator listing may be based on the region or location of the recipient 102, the transaction history of the recipient 102, the capacities of the recipient 102, and/or feedback associated with the recipient 102 (e.g., feedback previously submitted by the recipient 102 with respect to the suppliers 104 or assets 108).

The UAS operator listing may further be determined based, at least, on information in one or more of the suppliers' 104 supplier profiles. For example, the supplier's 104 organization or company, the supplier's 104 industry, the length of time that the supplier 104 has been in operation, a rating or other feedback relating to the supplier 104, a certification of the supplier 104, the region or location of the supplier 104, the transaction history of the supplier 104, and/or the assets 108 that the supplier 104 has made available on the platform 100.

Additionally, the determination of the UAS operator listing by the supplier recommendation component 212 may be based, at least, on information pertaining to the third-party support 106, such as information from the third-party support profiles. This may include an identification of one or more services offered by the third-party support 106, a region or location associated with the third-party support 106, a feedback relating to the third-party support 106, an availability of the third-party support 106, and/or an association of the third-party support 106 with one or more assets 108 and/or suppliers 104.

The feedback component 214 of the platform 100 may generate, receive, store, and/or provide feedback relating to, for example, the recipients 102, the suppliers 104, the third-party support 106, and/or the assets 108. The feedback may be in various forms, such as a rating (e.g., a number of stars or a score) or comment. The feedback may be prompted for and received from a platform 100 user (e.g., the recipient 102, the supplier 104, and/or the third-party support 106) in relation to a transaction, such as after a request for an operation of the asset 108. The feedback may be provided by a platform 100 user with respect to other parties to a transaction and the subject asset 108 of the transaction. For example, the recipient 102 may provide feedback for the supplier 104, the third-party support 106, and/or the asset 108. Conversely, the supplier 104 may provide feedback for the recipient 102 and/or the third-party support 106. In addition to the above, feedback may be provided in relation to a particular transaction, such as might be useful if the recipient 102 obtains usage of the same asset 108 from the same supplier 104 on separate occasions.

The third-party support recommendation component 216 may facilitate the recipient 102 selecting and/or procuring a service provided by the third-party support 106, such as a service to complement the use of the asset 108. For example, the third-party support 106 may provide supplemental data analytics, maintenance or repair services for the asset 108, licensing, and/or insurance relating to the asset 108. The third-party support recommendation component 216 may determine a listing of services offered by one or more of the third-party support 106. As examples, the listing of third-party support 106 services may be provided in conjunction with the viewing of an asset profile, in conjunction with a request from the recipient 102 to the supplier 104 to obtain use of the asset 108, and/or in conjunction with a completed agreement between the supplier 104 and the recipient 102 for the recipient 102. The determination of the listing of third-party support 106 services may be based, for example, on the various characteristics or aspects of the asset 108 included in the asset's 108 asset profile, the supplier 104 included in the supplier's 104 supplier profile, the recipient 102 included in the recipient's 102 recipient profile, and/or the terms of the usage.

The transaction component 218 may receive, store, and/or provide the transactions performed on the platform 100. A transaction may represent an agreement for the supplier 104 to provide operations using the asset 108 in return for consideration provided by the recipient 102. A transaction may include identifications of the supplier 104, the recipient 102, the third-party support 106, the asset 108, the price, and/or the term of the asset 108 usage (e.g., length of time, man-hours, operation-hours, or other metric of usage). The transaction component 218 may provide a transaction listing according to various criteria, such as those transactions involving the supplier 104, the recipient 102, the third-party support 106, or one of the assets 108. The transaction listing may be used to provide a transaction history which, in turn, may be used in the supplier profile, the recipient profile, the third-party support profile, and/or the asset profile. The transaction history may further be used in the supplier recommendation component 212 to determine a listing of recommended assets 108.

The platform 100 may further include the data analytics component 220. The data analytics component 220 may aggregate and analyze the various data received, stored, and/or provided to or by the platform 100. The data analytics component 220 may be wholly or partially implemented onboard the asset 108 such as a UAS. On board analytics include, for example, filtering, image processing, classifying, and data analytics of the information represented by the captured data. The data may also be transmitted external to the asset 108 for processing.

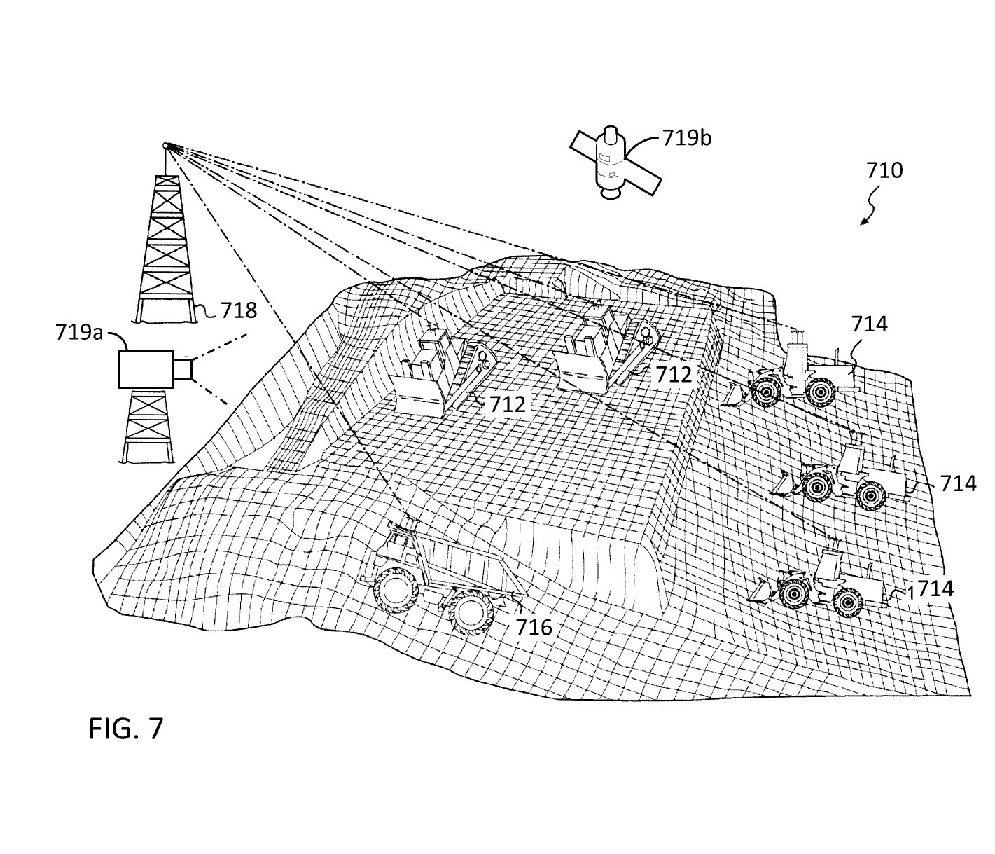

In certain aspects, data analytics of aerial data captured via a UAS may also process site data (e.g., machine data) relating to a particular site represented in the aerial data. Such sites may include a worksite 710 such as, for example, an open pit mining operation or a construction site, as illustrated in FIG. 7. As part of the mining function, for example, various machines may operate at or between different locations of the worksite 710. These machines may include, one or more digging machines 712, one or more loading machines 714, one or more hauling machines 716, one or more transport machines (not shown), and/or other types of machines or equipment known in the art. Other sites and machines, structures, and equipment may be included.

Each of the machines 712, 714, 716 at the worksite 710 may be in communication with each other and with a central station 718 by way of wireless communication (such as a communication channel as defined herein) to remotely transmit and receive operational data and instructions. Information relating to the machines 712, 714, 716 may be captured via an onsite sensor 719a such as a video camera, infrared sensor, thermal sensor, audio recorder, RADAR sensor, LIDAR sensor, optical sensor, or the like. Information relating to the machines 712, 714, 716 may be captured via an offsite sensor 719b, which may be disposed on a UAS, satellite, drone, aircraft, or other offsite device. The information captured via the sensors 719a, 719b may be transmitted to a processor such as the central station 718 by way of wireless communication (such as the communication channels defined herein). As such, the information captured via sensors 719a, 719b may be processed with information captured via assets 108, such as a UAS. This information may be filtered, aggregated, and otherwise pre-processed based upon known pre-processing techniques.

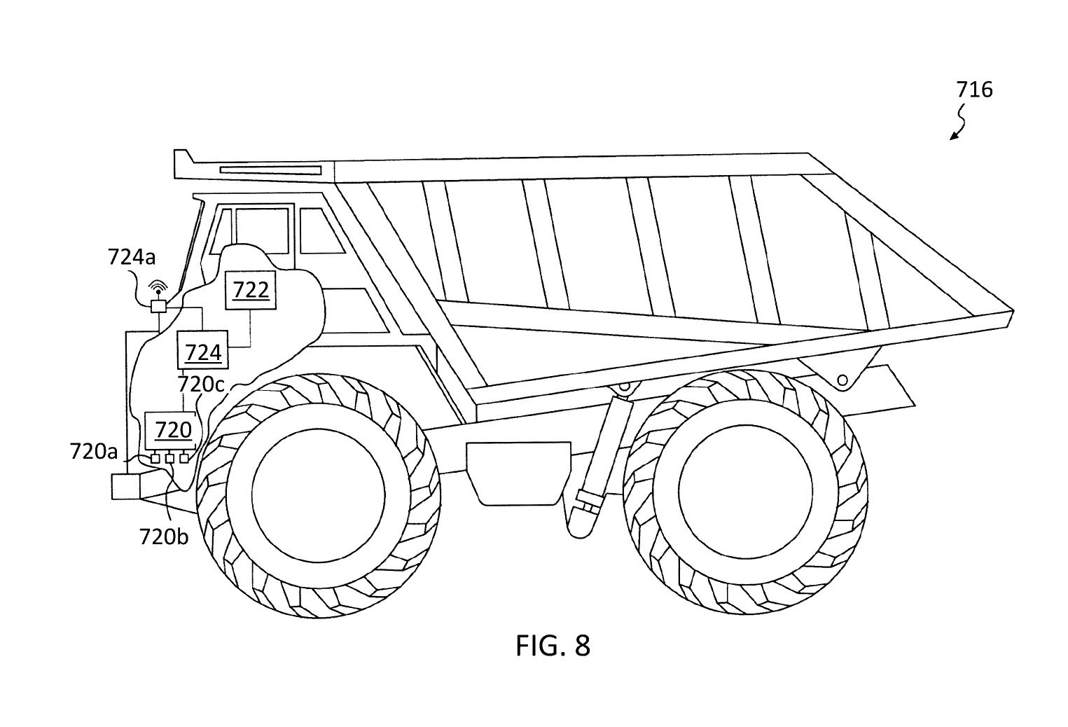

FIG. 8 shows one exemplary machine that may be operated at the worksite 710. It should be noted that, although the depicted machine may embody the hauling machine 716, the following description may be equally applied to any machine operating at the worksite 710. The hauling machine 716 may record and transmit data to the central station 718 (referring to FIG. 7) during its operation on a communication channel as defined herein. Similarly, the central station 718 may analyze the data and transmit information to the hauling machine 716 on a communication channel as defined herein. The data transmitted to the central station 718 may include payload data, operator data, machine identification data, performance data, worksite data, diagnostic data, and other data, which may be automatically monitored from onboard the hauling machine 716 and/or manually observed and input by machine operators. The information remotely transmitted back to the hauling machines 716 may include electronic terrain maps, machine configuration commands, instructions, recommendations and/or the like.

Payload data may include information relating to the material being hauled, processed, or displaced and may include binary state information of a material load such as full load or empty load, as well as, dynamic information such as payload material type (e.g., aggregate, ore, etc.), payload vs. air ratio (e.g., payload density), payload placement, amount of material moved, compaction, water content, drop placement, and the like. Payload data may relate to material being moved, compacted, shoveled, hauled, or other type of processing at a worksite. The term material load may refer to any material being processed at the worksite and is not so limited to a hauling process, for example.

Identification data may include machine-specific data, operator-specific data, location-specific data and/or the like. Machine-specific data may include identification data associated with a type of machine (e.g., digging, loading, hauling, planting, harvesting, irrigating, etc.), a make and model of machine (e.g., Caterpillar 797 OHT), a machine manufacture date or age, a usage or maintenance/repair history, etc. Operator-specific data may include an identification of a current operator, information about the current operator (e.g., a skill or experience level, an authorization level, an amount of time logged during a current shift, a usage history, etc.), a history of past operators, and the like. Site-specific data may include a task currently being performed by the operator, a current location at the worksite 710, a location history, a material composition at a particular area of the worksite 710, a site-imposed speed limit, etc.

Performance data may include current and historic data associated with operation of any machine at the worksite 710. Performance data may include, for example, payload information, efficiency information, productivity information, fuel economy information, speed information, traffic information, weather information, road and/or surface condition information, maneuvering information (e.g., braking, steering, wheel slip, etc.), downtime and repair or maintenance information, etc.

Diagnostic data may include recorded parameter information associated with specific components and/or systems of the machine. For example, diagnostic data may include engine temperatures, engine pressures, engine and/or ground speeds and acceleration, fluid characteristics (e.g., levels, contamination, viscosity, temperature, pressure, etc.), fuel consumption, engine emissions, braking conditions, transmission characteristics (e.g., shifting, torques, and speed), air and/or exhaust pressures and temperatures, engine calibrations (e.g., injection and/or ignition timings), wheel torque, rolling resistance, system voltage, etc. Some diagnostic data may be monitored directly, while other data may be derived or calculated from the monitored parameters. Diagnostic data may be used to determine performance data, if desired.

To facilitate the collection, recording, and transmitting of data from the machines at the worksite 710 to the central station 718 (referring to FIG. 7) and vice versa, each of the hauling machines 716 may include an onboard control module 720, an operator interface module 722, and a communication module 724. The communication module 724 may communicate over a communication channel as defined herein. Data received by the control module 720 and/or the operator interface module 722 may be sent offboard to the central station 718 by way of the communication module 724. The communication module 724 may also be used to send instructions and/or recommendations from the central station 718 to an operator of the hauling machine 716 by way of the operator interface module 722. It is contemplated that additional or different modules may be included onboard the hauling machine 716, if desired.

The control module 720 may include a plurality of sensors 720a, 720b, 720c distributed throughout the hauling machine 716 and/or the operator and configured to gather data from the operator and/or various components and subsystems of the hauling machine 716. It is contemplated that a greater or lesser number of sensors may be included than that shown in FIG. 8.

In an aspect, the sensors 720a-c may include any device that senses, detects, or measures a condition or state of the hauling machine 716. The sensors 720a-c may be directed toward sensing a machine state relating to the operation of the hauling machine 716 relative to a mine model or simulated plan. As an example, machine states may include, full load, empty load, payload material type, payload vs. air ratio (e.g., payload density), payload placement, drop placement, excavator position, idle state, swing, dump position, deformation of machine, and the like. The sensors 720a-c may include RADAR, LIDAR, infrared, thermal, audio, and/or an image capture device such as a video camera.

Machine states may relate to any information pertaining to the operation of a machine. Examples of data gathered from the sensors 720a-c include operator manipulation of the input devices, tool, or power source, machine velocity, machine location, fluid pressure, fluid flow rate, fluid temperature, fluid contamination level, fluid viscosity, electric current level, electric voltage level, fluid (e.g., fuel, water, oil) consumption rates, payload level, payload value, percent of maximum allowable payload limit, payload history, payload distribution, transmission output ratio, cycle time, idle time, grade, recently performed maintenance, or recently performed repair. Machine states may relate to an atypical operation for a particular machine and/or a deviation from best practices or a safety protocol, for example.

In another aspect, the sensors 720a-c may be associated with a power source (not shown), a transmission (not shown), a traction device, a work implement, an operator station, and/or other components and subsystems of the hauling machine 716. These sensors may be configured to provide data gathered from each of the associated components and subsystems. Other pieces of information may be generated or maintained by data control module 720 such as, for example, time of day, date, weather, road or surface conditions, and machine location (global and/or local).

The control module 720 may also be in direct communication with the separate components and subsystems of the hauling machine 716 to facilitate manual, autonomous, and/or remote monitoring and/or control of the hauling machine 716. For example, control module 720 may be in communication with the power source of the hauling machine 716 to control fueling, the transmission to control shifting, a steering mechanism to control heading, a differential lock to control traction, a braking mechanism to control deceleration, a tool actuator to control material dumping, and with other components and/or subsystems of the hauling machine 716. Based on direct commands from a human operator, remote commands from the central station 718 or another one of the machines 712, 714, 716 at the worksite 710, and/or self-direction, the control module 720 may selectively adjust operation of the components and subsystems of the hauling machine 716 to accomplish a predetermined task.

The operator interface module 722 may be located onboard the hauling machine 716 for collection and/or recording of data. The operator interface module 722 may include or be communicatively connected to one or more operator data input devices such as a press-able button, a movable dial, a keyboard, a touchscreen, a touchpad, a pointing device, or any other means by which an operator may indicate an aspect of his or her condition. For example, the operator interface module 722 may include a touchpad, which may be used by the operator to move a cursor on a display screen, such as an LCD screen, to select an indicator of the operator's condition. The data received via the operator interface module 722 may include observed information associated with the worksite 710, the hauling machine 716, and/or the operator.

The communication module 724 may include any device that facilitates communication of data between the hauling machine 716 and the central station 718, and/or between the machines 712, 714, 716. The communication module 724 may include hardware and/or software that enables sending and/or receiving data through a wireless communication link 724a. It is contemplated that, in some situations, the data may be transferred to the central station 718 and/or other machines 712, 714, 716 through a direct data link (not shown), or downloaded from the hauling machine 716 and uploaded to the central station 718, if desired. It is also contemplated that, in some situations, the data automatically monitored by the control module 720 may be electronically transmitted, while the operator-observed data may be communicated to the central station 718 by a voice communication device, such as a two-way radio (not shown).

The communication module 724 may also have the ability to record the monitored and/or manually input data. For example, the communication module 724 may include a data recorder (not shown) having a recording medium (not shown). In some cases, the recording medium may be portable, and data may be transferred from the hauling machine 716 to the central station 718 or between the machines 712, 714, 716 using the portable recording medium.

### INDUSTRIAL APPLICABILITY

The industrial applicability of the system for sharing equipment and personnel described herein will be readily appreciated from the foregoing discussion.

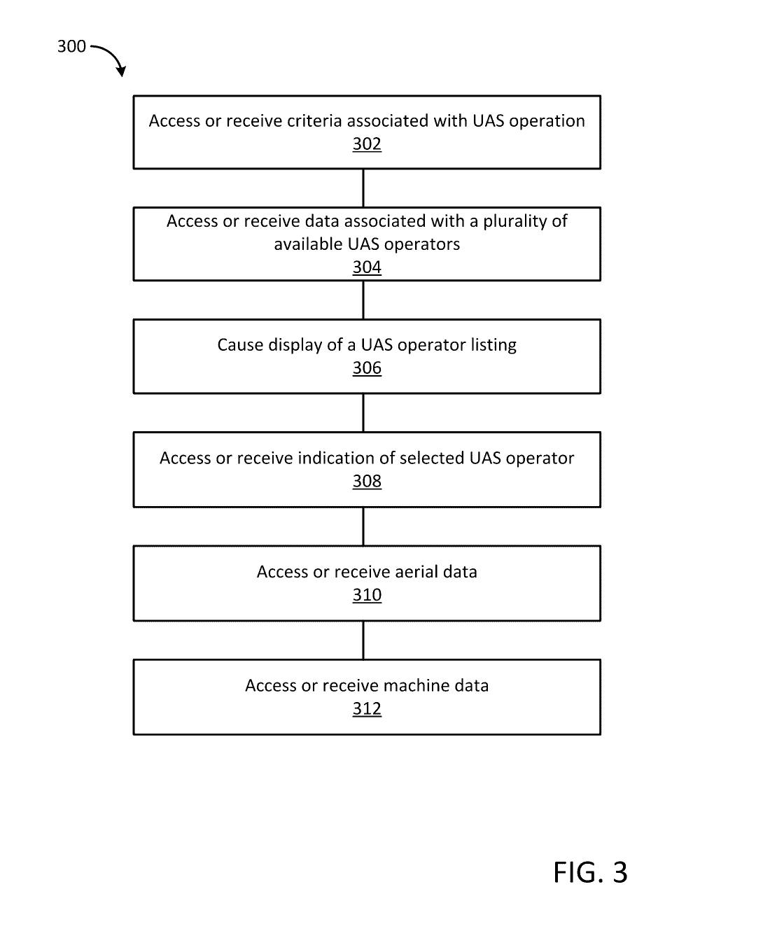

FIG. 3 illustrates a process flow chart for a method 300 in which a user, such as the recipient 102, of the platform 100 may obtain usage of one of the assets 108. For illustration, the operations of the method 300 will be discussed in reference to FIGS. 1 and 2. At step 302, first data may be received or accessed including a criteria associated with a UAS operation (e.g., a flight operation over a designated site). The criteria associated with the UAS operation may comprises an indication of a type of experience of the UAS operator, length of experience of the UAS operator, equipment available to the UAS operator, location of the UAS operator, availability schedule of the UAS operator, or analytics experience of the UAS operator, or a combination thereof. As an example, the criteria such as the length of experience or the type of experience may be specific to at least one of the following fields: rail, landfill, mining, forestry, or quarry. The criteria may comprise an indication of a region associated with the user. The criteria may comprise an analytics component such as an indication of moisture, an indication of ground density, a position of one or more haul roads, a quantity of trees, a degree of uniformity in a land area, or a three-dimensional model, or a combination thereof.

At step 304, second data may be received or accessed including data associated with a plurality of available UAS operators. Such data may include any information about the supplier 104 such as service characteristics. Examples of information may include a name, a picture, an organization or company name, an industry, a number of years in operation, staff information, a certification, a type of experience of the UAS operator, length of experience of the UAS operator, equipment available to the UAS operator, location of the UAS operator, availability schedule of the UAS operator, or analytics experience of the UAS operator.

At step 306, a UAS operator listing may be displayed. The UAS operating listing may include identifications of one or more UAS operators of the plurality of available UAS operators, the displayed UAS operator listing determined based, at least, on the first data and the second data. At step 308, an indication of a selected UAS operator from the one or more UAS operators of the UAS operator listing may be received or accessed. Such an indication may be received in response to a selection provided by a user, such as via a user interface. At step 310, aerial data may be received or accessed. The aerial data may first be collected via a UAS associated with the selected UAS operator and then transmitted to the user requesting such data. As an example, the aerial data may include analytics data based at least on the analytics criteria. At step 312, machine data may be received or accessed from one or more heavy machines situated in an area represented in the aerial data. As an example, the analytics data is based at least on the machine data.

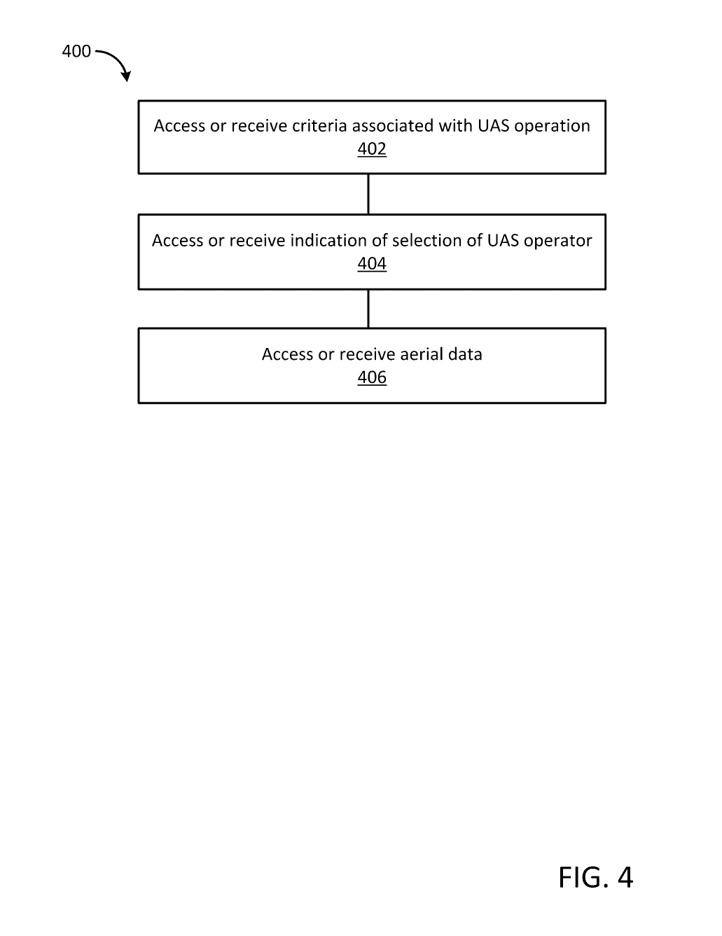

FIG. 4 illustrates a process flow chart for a method 400 in which a user, such as the recipient 102, of the platform 100 may obtain usage of one of the assets 108. For illustration, the operations of the method 400 will be discussed in reference to FIGS. 1 and 2. At step 402, a criteria associated with a UAS operation may be received or accessed. The criteria associated with the UAS operation may comprises an indication of a type of experience of the UAS operator, length of experience of the UAS operator, equipment available to the UAS operator, location of the UAS operator, availability schedule of the UAS operator, or analytics experience of the UAS operator, or a combination thereof. As an example, the criteria such as the length of experience or the type of experience may be specific to at least one of the following fields: rail, landfill, mining, forestry, or quarry. The criteria may comprise an indication of a region associated with the user. The criteria may comprise an analytics component such as an indication of moisture, an indication of ground density, a position of one or more haul roads, a quantity of trees, a degree of uniformity in a land area, or a three-dimensional model, or a combination thereof.

At step 404, a selection of a UAS operator from a UAS operator listing may be accessed or received. As an example, the UAS operator listing may be displayed via a user interface and the selection may be received as a user input. The UAS operator listing may include identifications of one or more available UAS operators based at least on the received criteria. At step 406, aerial data may be received or accessed. The aerial data may first be collected via a UAS associated with the selected UAS operator and then transmitted to the user requesting such data. As an example, the aerial data may include analytics data based at least on the analytics criteria. As a further example, the analytics data may be based at least on machine data relating to one or more machines situated in an area represented in the aerial data.

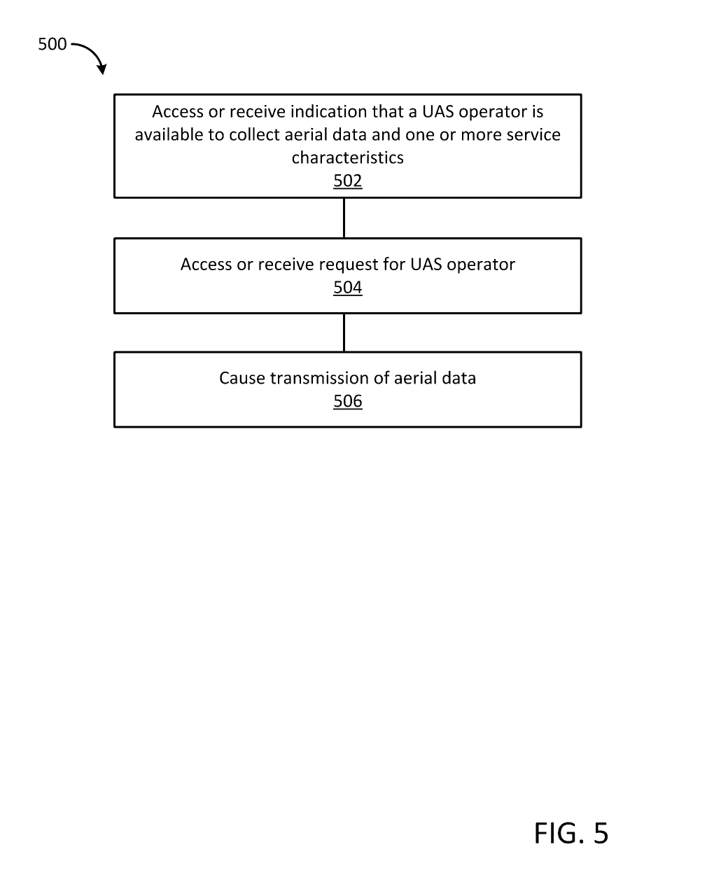

FIG. 5 illustrates a process flow chart for a method 500 in which a user, such as the recipient 102, of the platform 100 may obtain usage of one of the assets 108. For illustration, the operations of the method 500 will be discussed in reference to FIGS. 1 and 2. At step 502, first data may be received or accessed including an indication that a UAS operator is available to collect aerial data and one or more service characteristics of the UAS operator. As an example, the service characteristics associated with the UAS operator may include an indication of a type of experience of the UAS operator, length of experience of the UAS operators, equipment available to the UAS operator, location of the UAS operator, availability schedule of the UAS operator, or analytics experience of the UAS operator, or a combination thereof.

At step 504, a request may be accessed or received for the UAS operator to collect the aerial data using a UAS. The request may be transmitted to the UAS operator responsive to a selection from a UAS operator listing including identifications of one or more available UAS operators and determined based at least on the first data. At step 506, aerial data collected via the UAS associated with the UAS operator may be transmitted, for example to the source of the request. As a further example, the aerial data may include analytics data such as an indication of moisture, an indication of ground density, a position of one or more haul roads, a quantity of trees, a degree of uniformity in a land area, or a three-dimensional model, or a combination thereof.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., the platform 100 or one or more computing devices executing software embodying the platform 100) that implements a portion or all of one or more of the technologies described herein may include a general-purpose computer system that includes or is configured to access one or more computer-accessible media.

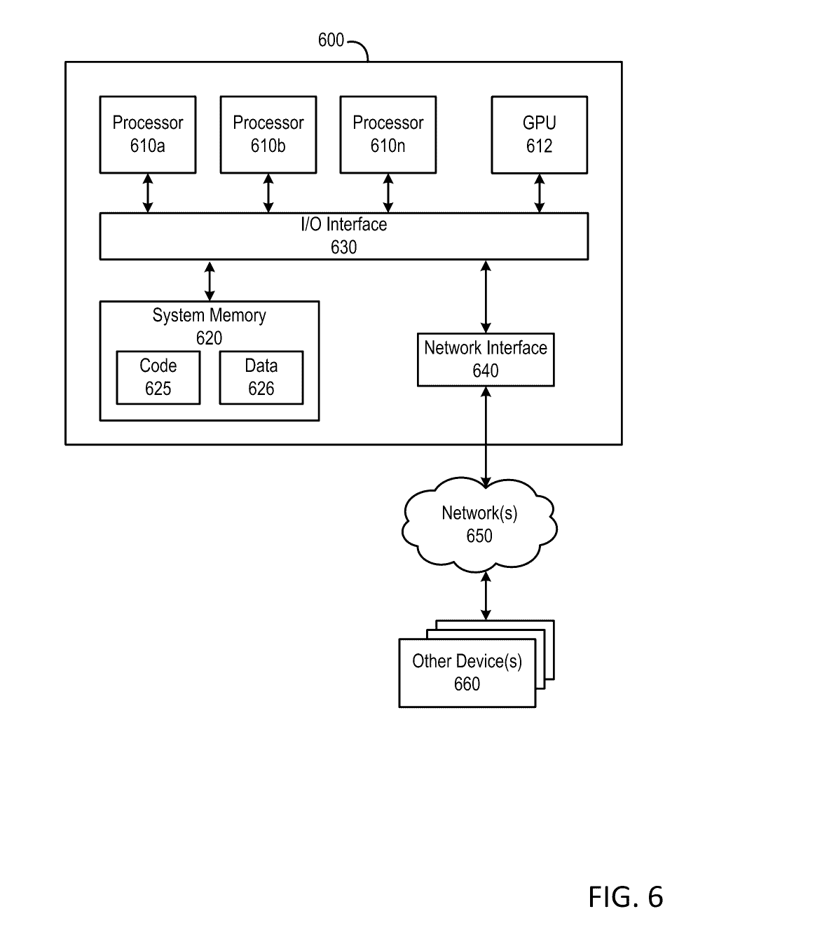

FIG. 6 depicts a general-purpose computer system that includes or is configured to access one or more computer-accessible media. In the illustrated aspect, a computing device 600 may include one or more processors 610a, 610b, and/or 610n (which may be referred herein singularly as the processor 610 or in the plural as the processors 610) coupled to a system memory 620 via an input/output (I/O) interface 630. The computing device 600 may further include a network interface 640 coupled to an I/O interface 630.

In various aspects, the computing device 600 may be a uniprocessor system including one processor 610 or a multiprocessor system including several processors 610 (e.g., two, four, eight, or another suitable number). The processors 610 may be any suitable processors capable of executing instructions. For example, in various aspects, the processor(s) 610 may be general-purpose or embedded processors implementing any of a variety of instruction set architectures (ISAs), such as the x86, PowerPC, SPARC, or MIPS ISAs, or any other suitable ISA. In multiprocessor systems, each of the processors 610 may commonly, but not necessarily, implement the same ISA.

In some aspects, a graphics processing unit (“GPU”) 612 may participate in providing graphics rendering and/or physics processing capabilities. A GPU may, for example, include a highly parallelized processor architecture specialized for graphical computations. In some aspects, the processors 610 and the GPU 612 may be implemented as one or more of the same type of device.

The system memory 620 may be configured to store instructions and data accessible by the processor(s) 610. In various aspects, the system memory 620 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 620 as code 625 and data 626.

In one aspect, the I/O interface 630 may be configured to coordinate I/O traffic between the processor(s) 610, the system memory 620 and any peripherals in the device, including a network interface 640 or other peripheral interfaces. In some aspects, the I/O interface 630 may perform any necessary protocol, timing or other data transformations to convert data signals from one component (e.g., the system memory 620) into a format suitable for use by another component (e.g., the processor 610). In some aspects, the I/O interface 630 may include support for devices attached through various types of peripheral buses, such as a variant of the Peripheral Component Interconnect (PCI) bus standard or the Universal Serial Bus (USB) standard, for example. In some aspects, the function of the I/O interface 630 may be split into two or more separate components, such as a north bridge and a south bridge, for example. Also, in some aspects some or all of the functionality of the I/O interface 630, such as an interface to the system memory 620, may be incorporated directly into the processor 610.

The network interface 640 may be configured to allow data to be exchanged between the computing device 600 and other device or devices 660 attached to a network or networks 650, such as other computer systems or devices, for example. In various aspects, the network interface 640 may support communication via any suitable wired or wireless general data networks, such as types of Ethernet networks, for example. Additionally, the network interface 640 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 620 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 600 via the I/O interface 630. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 600 as the system memory 620 or another type of memory. Further, a computer-accessible medium may include transmission media or signals, such as electrical, electromagnetic or digital signals, conveyed via a communication medium, such as a network and/or a wireless link, such as those that may be implemented via the network interface 640. Portions or all of multiple computing devices, such as those illustrated in FIG. 6, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A method for obtaining, by a user, aerial data collected by an unmanned aircraft system (UAS), the method comprising:
receiving, by one or more processors, first data comprising a criteria associated with a UAS operation, wherein the criteria comprises an analytics component;
receiving, by the one or more processors, second data comprising data associated with a plurality of available UAS operators;
causing, by the one or more processors, display of a UAS operator listing comprising identifications of one or more UAS operators of the plurality of available UAS operators, the displayed UAS operator listing determined based at least on the first data and the second data;
receiving, by the one or more processors, an indication of a selected UAS operator from the one or more UAS operators of the UAS operator listing; and
receiving aerial data collected via a UAS associated with the selected UAS operator, wherein the aerial data comprises analytics data based at least on the analytics component.

2. The method of claim 1, wherein the UAS operation comprises a flight over a designated site.

3. The method of claim 1, wherein the criteria associated with the UAS operation comprises an indication of a type of experience of the UAS operator, length of experience of the UAS operator, equipment available to the UAS operator, location of the UAS operator, availability schedule of the UAS operator, or analytics experience of the UAS operator, or a combination thereof.

4. The method of claim 3, wherein the indication of the length of experience or the type of experience is specific to at least one of the following fields: transportation, agriculture, pipeline, landfill, mining, forestry, construction, maritime, sub-terrain, and quarry.

5. The method of claim 1, wherein the criteria associated with the UAS operation comprises an indication of a region associated with the user.

6. The method of claim 1, wherein the data analytics component comprises an indication of moisture, an indication of ground density, a position of one or more haul roads, a quantity of trees, a degree of uniformity in a land area, or a three-dimensional model, or a combination thereof.

7. The method of claim 1, further comprising receiving machine data from one or more heavy machines situated in an area represented in the aerial data, wherein the analytics data is based at least on the machine data.

8. A method for comprising:
receiving, via a user interface, a criteria associated with an unmanned system operation wherein the criteria comprises an analytics component;
receiving, via the user interface, a selection of an operator from an operator listing displayed via the user interface, the operator listing comprising identifications of one or more available operators based at least on the received criteria; and
receiving data collected via an unmanned system associated with the selected operator, wherein the collected data comprises analytics data based at least on the analytics component.

9. The method of claim 8, wherein the unmanned system operation comprises a flight over a designated site.

10. The method of claim 8, wherein the criteria associated with the unmanned system operation comprises an indication of a type of experience of the operator, length of experience of the operator, equipment available to the operator, location of the operator, availability schedule of the operator, or analytics experience of the operator, or a combination thereof.

11. The method of claim 10, wherein the indication of the length of experience or the type of experience is specific to at least one of the following fields: transportation, agriculture, pipeline, landfill, mining, forestry, construction, maritime, sub-terrain, and quarry.

12. The method of claim 8, wherein the criteria associated with the unmanned system operation comprises an indication of a region associated with the user.

13. The method of claim 8, wherein the data analytics component comprises an indication of moisture, an indication of ground density, a position of one or more haul roads, a quantity of trees, a degree of uniformity in a land area, or a three-dimensional model, or a combination thereof.

14. The method of claim 8, wherein the analytics data is based at least on machine data relating to one or more machines situated in an area represented in the aerial data.

15. A method of providing, by an unmanned aircraft system (UAS) operator and to a user, aerial data collected by the UAS, the method comprising:
receiving, via a user interface, first data comprising an indication that a UAS operator is available to collect aerial data and one or more service characteristics of the UAS operator;
receiving a request for the UAS operator to collect the aerial data using a UAS, the request being transmitted to the UAS operator responsive to a selection from a UAS operator listing comprising identifications of one or more available UAS operators and determined based at least on the first data; and
causing transmission of aerial data collected via the UAS associated with the UAS operator, wherein the aerial data comprises analytics data.

16. The method of claim 15, wherein the service characteristics associated with the UAS operator comprise an indication of a type of experience of the UAS operator, length of experience of the UAS operator, equipment available to the UAS operator, location of the UAS operator, availability schedule of the UAS operator, or analytics experience of the UAS operator, or a combination thereof.

17. The method of claim 15, wherein the indication of the type of experience is specific to at least one of the following fields: transportation, agriculture, pipeline, landfill, mining, forestry, construction, maritime, sub-terrain, and quarry.

18. The method of claim 15, wherein the indication of the length of experience is specific to at least one of the following fields: transportation, agriculture, pipeline, landfill, mining, forestry, construction, maritime, sub-terrain, and quarry.

19. The method of claim 15, wherein the selection of the UAS operator from the UAS operator listing is based at least in part on a region associated with the user.

20. The method of claim 15, wherein the data analytics data comprises an indication of moisture, an indication of ground density, a position of one or more haul roads, a quantity of trees, a degree of uniformity in a land area, or a three-dimensional model, or a combination thereof.
